(19) United States
(12) Patent Application Publication
(10) Pub. No.: US 2013/0088360 A1
(43) Pub. Date: Apr. 11, 2013

(54) SUBSEA OPTICAL SWITCH

(71) Applicants: Daniel McStay, Aberdeenshire (GB); David Faichnie, Lennoxtown (GB)

(72) Inventors: Daniel McStay, Aberdeenshire (GB); David Faichnie, Lennoxtown (GB)

(21) Appl. No.: 13/521,940

(22) PCT Filed: Feb. 10, 2010
(86) PCT No.: PCT/US10/23698

§ 371 Date: Nov. 20, 2012

(51) Int. Cl. G01V 8/10

(52) U.S. Cl. CPC G01V 8/10
USPC 340/850

(57) ABSTRACT

An optical monitoring system includes a sensor network including a plurality of optical sensors. The optical switch module is disposed on a first side of a pressure barrier, coupled to the sensor network, and operable to select various subsets of the optical sensors responsive to a control signal. The sensor interrogation unit is disposed on a second side of the pressure barrier and operable to generate the control signal and receive an optical signal from a particular subset of the sensor elements selected by the optical switch module. The optical penetrator is coupled to the interrogation unit and the optical switch module and operable to communicate the optical signal through the pressure barrier. The inductive control unit is operable to inductively communicate the control signal and a power signal to the optical switch module through the pressure barrier.

### BACKGROUND OF THE INVENTION

The disclosed subject matter relates generally to subsea hydrocarbon production and, more particularly, to a subsea optical switch.

In order to control a subsea well, a connection is established between the well and a monitoring and control station. The monitoring and control station may be located on a platform or floating vessel near the subsea installation, or alternatively in a more remote land station. The connection between the control station and the subsea installation is usually established by installing an umbilical between the two points. The umbilical may include hydraulic lines for supplying hydraulic fluid to various hydraulic actuators located on or near the well. The umbilical may also include electrical and or fiber optic lines for supplying electric power and also for communicating control signals and/or well data between the control station and the various monitoring and control devices located on or near the well.

Hydrocarbon production from the subsea well is controlled by a number of valves that are assembled into a unitary structure generally referred to as a well tree or Christmas tree. Well tree and wellhead systems have the principle functions of providing an interface to the in-well environment, allowing flow regulation and measurement, and permitting intervention on the well or downhole systems during the operational life of the well. The actuation of the valves in the well tree is normally provided using hydraulic fluid to power hydraulic actuators that operate the valves. Hydraulic fluid is normally supplied through an umbilical running from a remote station located on a vessel or platform at the surface. Alternative systems using electrically based actuators are also possible.

In addition to the flow control valves and actuators, a number of sensors and detectors are commonly employed in subsea systems to monitor the state of the system and the flow of hydrocarbons from the well. Often a number of sensors, detectors and/or actuators are also located downhole. All these devices are controlled and/or monitored by a dedicated control system, which is usually housed in the remote control module. Control signals and well data are also exchanged through the umbilical.

Conventional well trees typically only have a few sensors designed to provide information on the production process. These sensors fail to provide any information regarding the operation or efficiency of the well tree or wellhead. If a particular sensor fails to operate accurately, it may provide errant information regarding the production process. Uncertainties in the accuracy of the well monitoring and the limited amount of data make it difficult to optimize the production process or to predict impending failures.

Optoelectronic sensors and communications systems are useful for providing measurements and transmitting data required for subsea hydrocarbon production installations. There are a number of optoelectronic sensing schemes, such as Raman based distributed temperature sensing and arrays of Bragg gratings, that provide multiple sensors or sensing points along a single optical fiber. However not all the sensors required for such subsea installations can be easily accessed. In many instances the use of individual optical fiber devices and sensors at various locations on subsea installations requires direct cabling between the sensor and the Subsea Control Module (SCM) or other subsea hub arrangement.

A major limitation in deploying optical devices is the cost of the connectors or feed through between the subsea environment and the inside of the SCM. The cost, per sensor, even when using a multi-fiber connector system, is very high. There are also physical limitations on the number of such connectors that can be installed on a typical SCM, which in turn limits the number of sensors that can be deployed on a subsea installation. These cost and physical limitations greatly restrict the use of directly connected optical devices and sensors on subsea hydrocarbon installations.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY OF THE INVENTION

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in an optical monitoring system that includes a sensor network. The sensor network includes a plurality of optical sensors. The optical switch module is disposed on a first side of a pressure barrier, coupled to the sensor network, and operable to select various subsets of the optical sensors responsive to a control signal. The sensor interrogation unit is disposed on a second side of the pressure barrier and operable to generate the control signal and receive an optical signal from a particular subset of the sensor elements selected by the optical switch module. The optical penetrator is coupled to the interrogation unit and the optical switch module and operable to communicate the optical signal through the pressure barrier. The inductive control unit is operable to inductively communicate the control signal and a power signal to the optical switch module through the pressure barrier.

Another aspect of the disclosed subject matter is seen in a method for monitoring a sensor network including a plurality of optical sensors. The method includes coupling an optical switch module disposed on a first side of a pressure barrier to the sensor network. The optical switch module is operable to select various subsets of the optical sensors responsive to a control signal. A sensor interrogation unit is provided on a second side of the pressure barrier and operable to generate the control signal and receive an optical signal from a particular subset of the sensor elements selected by the optical switch module. An optical penetrator coupled to the interrogation unit and the optical switch module is provided and is operable to communicate the optical signal through the pressure barrier. The control signal and a power signal is inductively communicated to the optical switch module through the pressure barrier.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a simplified diagram of a subsea installation for hydrocarbon production;

FIG. 2 is a perspective view of an exemplary well tree in the system of FIG. 1;

FIG. 3 is a view of the well tree of FIG. 2 illustrating monitoring sensors;

FIG. 4 is a simplified diagram of an optical routing system that may be used to support monitoring of the well tree of FIGS. 1-3; and

FIG. 5 is a diagram illustrating an embodiment of a sensor network that may be used in the routing system of FIG. 4.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION OF THE INVENTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

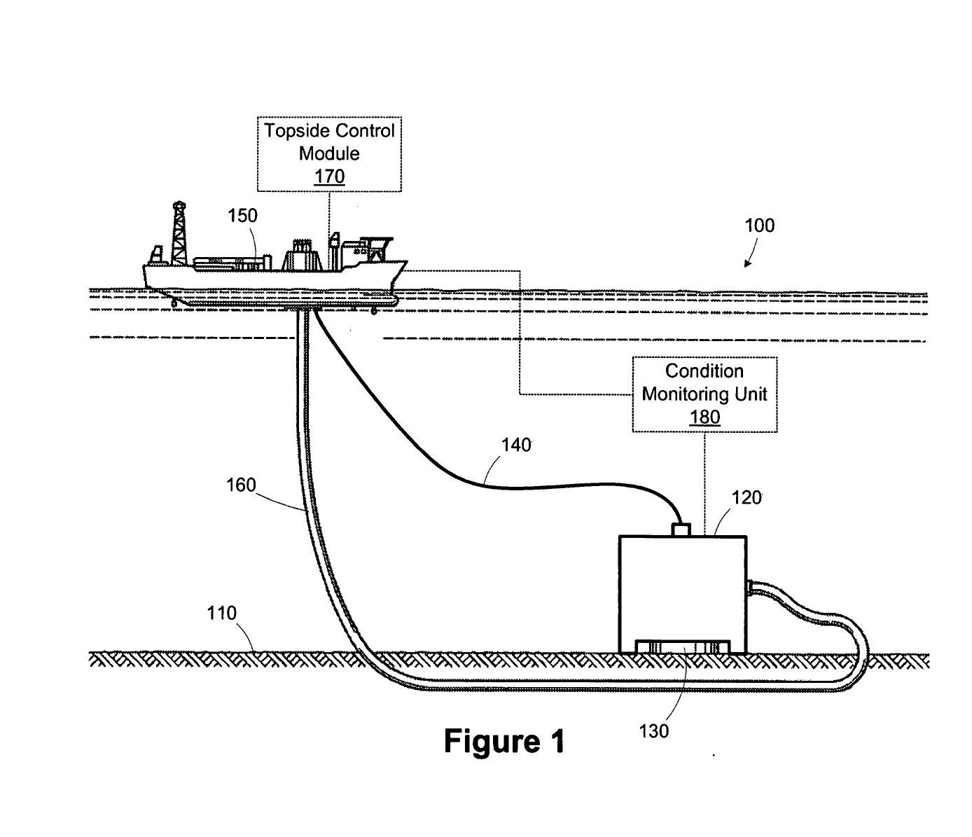

Referring now to the drawings wherein like reference numbers correspond to similar components throughout the several views and, specifically, referring to FIG. 1, the disclosed subject matter shall be described in the context of a subsea installation 100 located on the seabed 110. The installation 100 includes a schematically depicted well tree 120 mounted on a wellhead 130. The wellhead 130 is the uppermost part of a well (not shown) that extends down into the sea floor to a subterranean hydrocarbon formation. An umbilical cable 140 for communicating electrical signals, fiber optic signals, and/or hydraulic fluid extends from a vessel 150 to the well tree 120. In other embodiments, the vessel 150 may be replaced by a floating platform or other such surface structure. In one illustrative embodiment, a flowline 160 also extends between the vessel 150 and the well tree 120 for receiving hydrocarbon production from the well. In some cases, the flowline 160 and a communications line (not shown) may extend to a subsea manifold or to a land based processing facility. A topside control module (TCM) 170 is housed on the vessel 150 to allow oversight and control of the well tree 120 by an operator. A condition monitoring unit 180 is provided for monitoring the operation of the well tree 120. The operation of the conduction monitoring unit is described in more detail in U.S. patent application Ser. No. 12/204,311, entitled “Optical Sensing System for Wellhead Equipment,” which is incorporated herein by reference in its entirety.

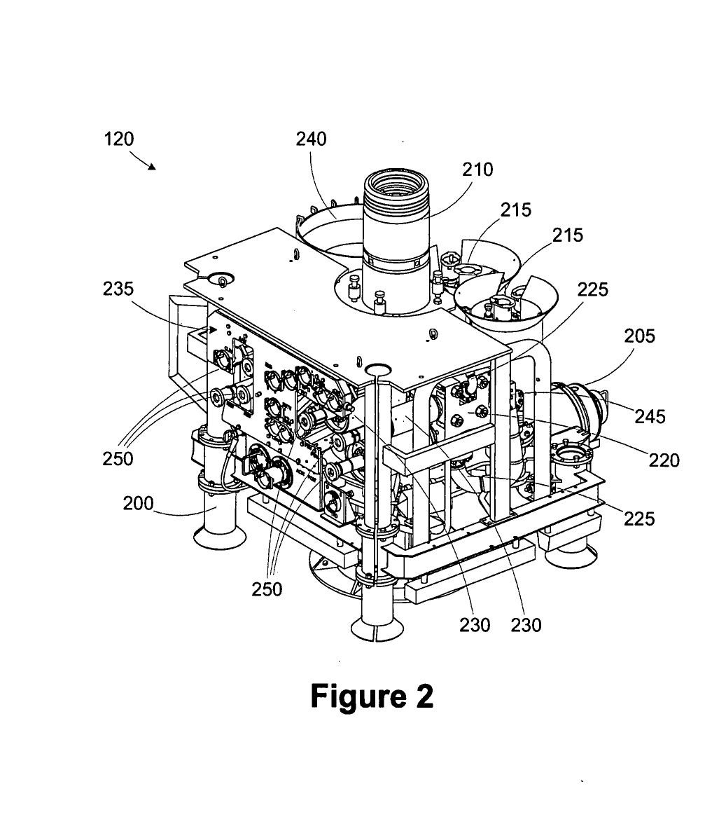

FIG. 2 illustrates a perspective view of an exemplary well tree 120. The well tree 120 illustrated in FIG. 2 is provided for illustrative purposes, as the application of the present subject matter is not limited to a particular well tree design or structure. The well tree 120 includes a frame 200, a flowline connector 205, a composite valve block assembly 210, chokes 215, a production wing valve 220, flow loops 225, hydraulic actuators 230, a remotely operated vehicle (ROV) panel 235, a subsea control module (SCM) 240, and fluid sensors 245. Within the ROV panel 235, hydraulic actuator linear overrides 250 and ROV interface buckets 255 are provided for allowing the operation of the actuators 230 or other various valves and components by an ROV (not shown). Although certain embodiments described below employ components that are hydraulically operated, it is contemplated that corresponding electrically operated components may also be used.

The construct and operation of the components in the well tree 120 are well known to those of ordinary skill in the art, so they are not described in detail herein. Generally, the flow of production fluid (e.g., liquid or gas) through the flowline 160 is controlled by the production wing valve 220 and the chokes 215, which are positioned by manipulating the hydraulic actuators 230. The composite valve block assembly 210 provides an interface for the umbilical 140 to allow electrical signals (e.g., power and control) and hydraulic fluid to be communicated between the vessel 150 and the well tree 120. The flow loops 225 and fluid sensors 245 are provided to allow characteristics of the production fluid to be measured. The subsea control module (SCM) 240 is the control center of the well tree 120, providing control signals for manipulating the various actuators and exchanging sensor data with the topside control module 170 on the vessel 150.

The functionality of the condition monitoring unit 180 may be implemented by the topside control module 170 or the subsea control module 240 (i.e., as indicated by the phantom lines in FIG. 1. The condition monitoring unit 180 may be implemented using dedicated hardware in the form of a processor or computer executing software, or the condition monitoring unit 180 may be implemented using software executing on shared computing resources. For example, the condition monitoring unit 180 may be implemented by the same computer that implements the topside control module 170 or the computer that implements the SCM 240.

Generally, the condition monitoring unit 180 monitors various parameters associated with the well tree 120 to determine the “health” of the well tree 120. The health information derived by the well tree 120 includes overall health, component health, component operability, etc. Exemplary parameters that may be monitored include pressure, temperature, flow, vibration, corrosion, displacement, rotation, leak detection, erosion, sand, strain, and production fluid content and composition. To gather data regarding the parameters monitored, various sensors may be employed.

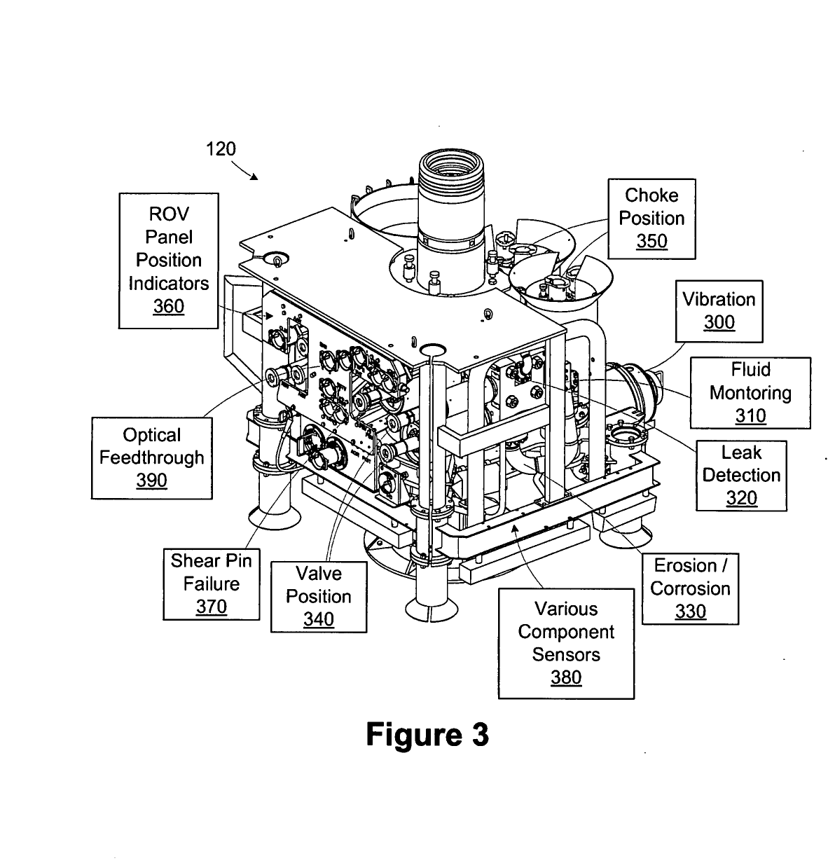

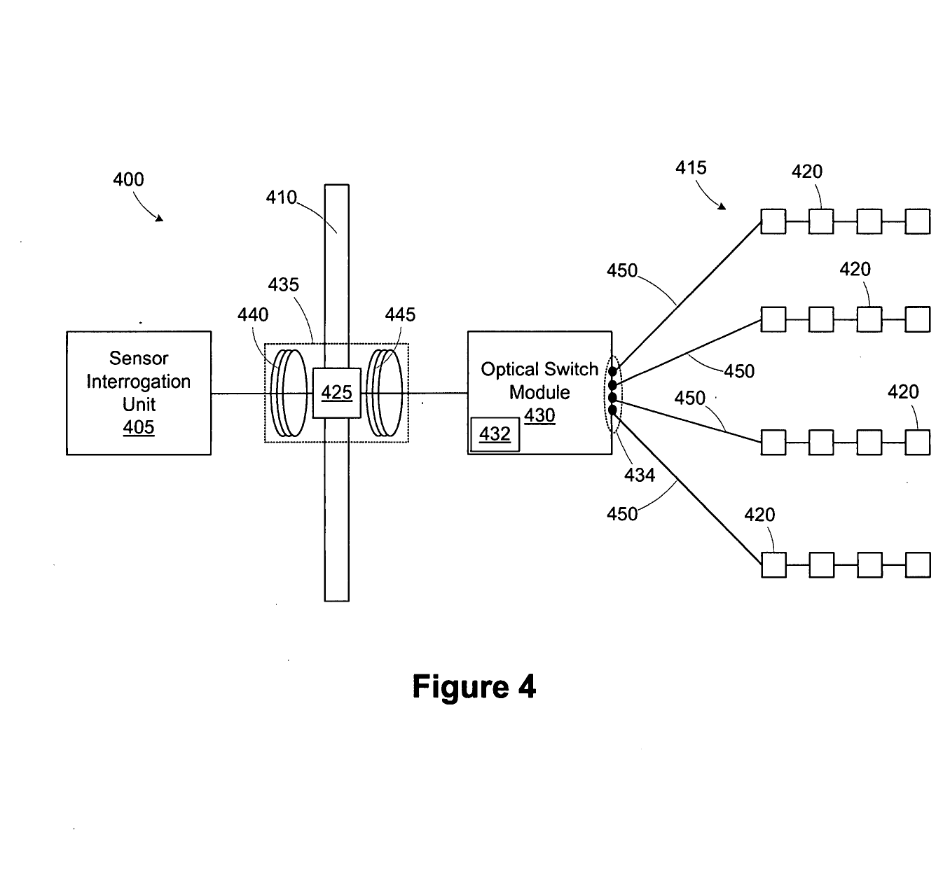

FIG. 3 illustrates a diagram of the well tree 120 showing various illustrative monitoring points. These monitoring points may be provided through the use of optical sensors as further described in reference to FIG. 4. An exemplary, but not exhaustive, list of optical sensors is provided below. Also, various signals associated with the components (e.g., motor current, voltage, vibration, or noise) may also be considered. As shown in FIG. 3, a vibration sensor 300 may be provided for detecting vibration in the flowline 160. Fluid Monitoring sensors 310 may be provided for monitoring characteristics of the production fluid, such as pressure, temperature, oil in water concentration, chemical composition, etc. One or more leak detection sensors 320 may be provided for monitoring connection integrity. Erosion and/or corrosion sensors 330 may be provided in the flow loops 225. Valve position sensors 340, choke position sensors 350, and ROV panel position indicators 360 may be provided for monitoring the actual valve positions. Shear pin failure sensors 370 may be provided for monitoring the hydraulic actuators 230 and linear overrides 250. Other various component sensors 380 may also be provided for monitoring parameters, such as motor voltage, motor current, pump characteristics, etc. The sensors 300-380 may communicate through an optical feedthrough module 390 to the topside control module 170.

In general, the optical feedthrough module 390 is housed in a horizontal penetrator and provides an optical path between the well tree 120 and the topside control module 170 and/or the condition monitoring unit 180. Although a horizontal penetrator is illustrated, it is also contemplated that a vertically oriented penetrator may also be employed. The optical feedthrough module 390 may take on various forms. In one embodiment, the optical feedthrough module 390 includes an optically transmissive window that includes optical repeaters on either side of the window that allow an optical signal to be communicated between entities inside the well tree 120 pressure barrier to entities outside the pressure barrier. In the case of an optical window, no actual opening is defined in the pressure barrier. In another embodiment, the optical feedthrough module 390 may comprise a penetration that breaches the pressure boundary to allow an optical cable to pass through the housing.

In some embodiments, multiple sensors may be provided for measuring a particular parameter. For example, multiple voltage and current sensors may be provided to allow measurement of standard motor performance voltage and current as well as voltage or current surges, spikes, etc. The duplicate sensors provide both built in redundancy and a means for cross-checking sensor performance.

Turning now to FIG. 4, a simplified diagram of an optical routing system 400 that may be used to support monitoring of the well tree 120 is provided. Although the optical routing system 400 is described as it is implemented for monitoring a well tree 120, its application is not limited. The optical routing system 400 may be used for virtually any subsea or harsh environment monitoring application where a pressure boundary exists between the sensors and the monitoring electronics. For example, the optical routing system 400 may be used in a subsea production system or other subsea equipment.

In general, a sensor interrogation unit 405 communicates through a pressure barrier 410 to a sensor network 415 including a plurality of sensor elements 420. An optical penetrator 425 (e.g., the optical feedthrough 390) is provided to bridge the pressure barrier 410. An optical switch module 430 is provided for interfacing with the sensor network 415 to select particular subsets of the sensor elements 420 to facilitate communication with the sensor interrogation unit 405. In one embodiment, the sensor interrogation unit 405 is housed in the SCM 240 and communicates with sensor elements 420 disposed throughout the well tree 120 for monitoring various parameters of the well tree 120.

The optical switch module 430 may have a variety of constructions, including a micro-electro-mechanical system (MEMS) or an opto-mechanical system. The optical switch module 430 is powered by an inductive control unit 435 that includes a inductive transmitter coil 440 disposed on the side of the pressure barrier 410 including the sensor interrogation unit 405 and a inductive receiver coil 445 disposed on the same side of the pressure barrier as the optical switch module 430. A variety of modes of operation may be employed for the inductive control unit 435. For example, the power and control signals may be at different frequencies. The inductive control unit 435 may also contain smoothing and/or surge protection electronics to minimize the potential for damage to electronics of the optical switch module 430 and to provide the appropriate switching signal. The sensor interrogation unit 405 and the inductive receiver coil 445 may receive electrical power from a common source (e.g., through the umbilical 140). The inductive control unit 435 allows the optical switch module 430 to be controlled without requiring an additional penetrator through the pressure barrier 410 to power the optical switch module 430. The inductive coils 440, 445 may be disposed close to the optical penetrator 425 or integrated therewith. The wall of the pressure barrier 410 may be modified in the region where the inductive signal transfer occurs to increase the efficiency of the signal transfer. For example, the metal composition thickness, or structure of the pressure barrier 410 may be varied. In one embodiment, the optical switch module 430 may include a battery 432 that provides primary power for positioning the switch, while the inductive control unit 435 is provided for charging the battery 432 and communicating the control signals.

The arrangement of the sensor elements 420 in the sensor network 415 may vary depending on the particular parameters monitored and any multiplexing scheme employed. There are a number of optoelectronic sensing schemes, such as Raman based distributed temperature sensing or arrays of Bragg gratings, that provide multiple sensors or sensing points along a single optical fiber. The optical switch module 430 enables the sensor interrogation unit 405 to select a single optical fiber for interrogation. In cases where the sensors on each fiber use the same form of identification (e.g., wave division multiplexing (WDM), the sensor interrogation unit 405 may still uniquely identify each sensor based on the position of the optical switch module 430 and the identification data.

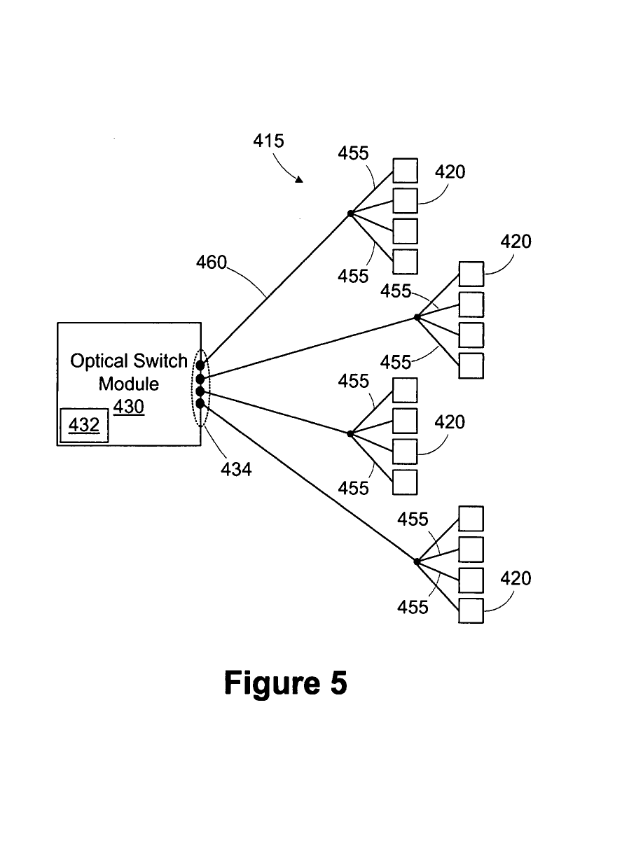

In the embodiment illustrated in FIG. 4, multiple sensor elements 420 are each disposed on a optical fiber 450. Each optical fiber 450 is coupled to an output port 434 of the optical switch module 430. Alternatively, as shown in FIG. 5, the sensor network 415 may include multiplexed sensor elements 420 that are disposed on multiple branches 455 of an optical fiber 460. The branching arrangement is useful for locating sensor elements 420 at various measurement points on the well tree 120 or other portions of the subsea processing system.

The optical routing system 400 described herein has numerous advantages. The number of optical sensor elements 420 used for monitoring the well tree 120 or other equipment may be increased significantly without introducing the physical and cost problems associated with additional pressure barrier penetrations.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. An optical monitoring system, comprising:
a sensor network including a plurality of optical sensors;
an optical switch module disposed on a first side of a pressure barrier, coupled to the sensor network, and operable to select various subsets of the optical sensors responsive to a control signal;
a sensor interrogation unit disposed on a second side of the pressure barrier and operable to generate the control signal and receive an optical signal from a particular subset of the sensor elements selected by the optical switch module;
an optical penetrator coupled to the interrogation unit and the optical switch module and operable to communicate the optical signal through the pressure barrier; and
an inductive control unit operable to inductively communicate the control signal and a power signal to the optical switch module through the pressure barrier.

2. The system of claim 1, wherein the inductive control unit comprises:
a transmitting coil disposed on the second side of the pressure barrier; and
a receiving coil disposed on the first side of the pressure barrier.

3. The system of claim 2, wherein the sensor interrogation unit and the transmitting coil are powered from a common power source.

4. The system of claim 1, wherein the inductive control unit is operable to transmit the control signal using a first frequency and transmit the power signal using a second frequency different than the first frequency.

5. The system of claim 1, wherein the optical switch module includes a battery, and the inductive control unit is operable to provide the power signal to the battery.

6. The system of claim 1, wherein the sensor network includes a plurality of optical fibers, wherein a plurality of sensor elements are disposed on at least some of the optical fibers.

7. The system of claim 1, wherein the sensor network includes an optical fiber with a plurality of branches, wherein at least one sensor element is disposed on each branch.

8. The system of claim 1, wherein the sensor network includes a plurality of optical fibers, each optical fiber being connected to a different output port of the optical switch.

9. The system of claim 8, wherein the sensor elements on at least two of the optical fibers use a common identification scheme, and the interrogation unit is operable to uniquely address the sensor elements based on the identification scheme and the particular output port associated with the optical fiber.

10. A system, comprising:
a well tree assembly mounted to a hydrocarbon well;
a sensor network including a plurality of optical sensors disposed within the well tree assembly for measuring parameters associated with the well tree assembly;
an optical switch module disposed on a first side of a pressure barrier defined by the well tree assembly, coupled to the sensor network, and operable to select various subsets of the optical sensors responsive to a control signal;
a sensor interrogation unit disposed on a second side of the pressure barrier and operable to generate the control signal and receive an optical signal from a particular subset of the sensor elements selected by the optical switch module;
an optical penetrator coupled to the interrogation unit and the optical switch module and operable to communicate the optical signal through the pressure barrier; and
an inductive control unit operable to inductively communicate the control signal and a power signal to the optical switch module through the pressure barrier.

11. The system of claim 10, wherein the well tree assembly includes a subsea control module, and wherein a wall of the subsea control module defines the pressure barrier.

12. The system of claim 10, wherein the inductive control unit comprises:
a transmitting coil disposed on the second side of the pressure barrier; and
a receiving coil disposed on the first side of the pressure barrier.

13. The system of claim 12, wherein the sensor interrogation unit and the transmitting coil are powered from a common power source.

14. The system of claim 10, wherein the inductive control unit is operable to transmit the control signal using a first frequency and transmit the power signal using a second frequency different than the first frequency.

15. The system of claim 10, wherein the optical switch module includes a battery, and the inductive control unit is operable to provide the power signal to the battery.

16. The system of claim 10, wherein the sensor network includes a plurality of optical fibers, wherein a plurality of sensor elements are disposed on at least some of the optical fibers.

17. The system of claim 10, wherein the sensor network includes an optical fiber with a plurality of branches, wherein at least one sensor element is disposed on each branch.

18. The system of claim 10, wherein the sensor network includes a plurality of optical fibers, each optical fiber being connected to a different output port of the optical switch.

19. The system of claim 18, wherein the sensor elements on at least two of the optical fibers use a common identification scheme, and the interrogation unit is operable to uniquely address the sensor elements based on the identification scheme and the particular output port associated with the optical fiber.

20. A method for monitoring a sensor network including a plurality of optical sensors, comprising:
coupling an optical switch module disposed on a first side of a pressure barrier to the sensor network, the optical switch module being operable to select various subsets of the optical sensors responsive to a control signal;
providing a sensor interrogation unit disposed on a second side of the pressure barrier and operable to generate the control signal and receive an optical signal from a particular subset of the sensor elements selected by the optical switch module;
providing an optical penetrator coupled to the interrogation unit and the optical switch module and operable to communicate the optical signal through the pressure barrier; and
inductively communicate the control signal and a power signal to the optical switch module through the pressure barrier.
